(19) United States
(12) Patent Application Publication
(10) Pub. No.: US 2024/0394814 A1
(43) Pub. Date: Nov. 28, 2024

(54) SYSTEMS AND METHODS FOR PROVIDING A PROJECT MANAGEMENT AND CRM PLATFORM FOR REAL ESTATE, MORTGAGE AND OTHER TRANSACTIONS

(71) Applicant: Trackxi, Inc.

(72) Inventor: Vijay Gopalswamy, Portland, OR (US)

(21) Appl. No.: 18/676,158

(22) Filed: May 28, 2024

Related U.S. Application Data
(60) Provisional application No. 63/455,139, filed on Mar. 28, 2023.

(51) Int. Cl. G06Q 50/16; G06F 3/0482; G06Q 10/0631; G06Q 10/10

(52) U.S. Cl. CPC G06Q 50/16; G06Q 10/063114; G06Q 10/103; G06F 3/0482

(57) ABSTRACT

A system for providing a project management platform is disclosed, including at least one user computing device in operable connection with a user network. An application server is in operable communication with the user network to host an application system for providing a real estate management platform. The application system includes a user interface module for providing access to the application program through the user computing device. A tasks module is in communication with the application program to monitor and display information related to one or more tasks associated with a transaction and a transactions module monitors and displays information associated with the transaction. Users are able to view a comprehensive list of tasks associated with a transaction providing an end-to-end view of the transaction progress. Tasks are color-coded to provide an efficient means of discerning a status associated with the task. Processes are automated using an AI/ML engine.

### CROSS-REFERENCE TO RELATED APPLICATIONS

The present application claims priority to U.S. Provisional Application No. 63/455,139 filed Mar. 28, 2023, titled “SYSTEMS AND METHODS FOR PROVIDING A PROJECT MANAGEMENT AND CRM PLATFORM FOR REAL ESTATE, MORTGAGE AND OTHER TRANSACTIONS,” which is hereby incorporated by reference in its entirety.

### TECHNICAL FIELD

Embodiments of the invention relate to systems and methods providing a project management platform.

### BACKGROUND

Many businesses employ project management & Customer Relationship Management (CRM) tools to manage the life cycle of a project and clients associated therewith. In particular, real estate transactions are complex processes in which rights to property is transferred between two or more parties. The process is often complicated due to a number of factors including the complexity of the property rights being transferred, amount of money being exchanges, presence of loans and other agreements, and government regulations. In some examples, the real estate transaction process may include many (or all) of the following steps such as hiring a real estate broker, buyer engagement, advertisement of the price and property, private or public showings of the property, pre-approval of the buyer, contract negotiation and acceptance, submission of offers, appraisals, inspections, and closing of the transaction. This also includes many other parties like Mortgage brokers, Title/Escrow companies, Lawyers, Contractors and others.

### SUMMARY OF THE INVENTION

This summary is provided to introduce a variety of concepts in a simplified form that is disclosed further in the detailed description of the embodiments. This summary is not intended for determining or limiting the scope of the claimed subject matter.

The embodiments provide a system for providing a project management platform, including at least one user computing device in operable connection with a user network. An application server is in operable communication with the user network to host an application system for providing a real estate management platform. The application system includes a user interface module for providing access to the application program through the user computing device. A tasks module is in communication with the application program to monitor and display information related to one or more tasks associated with a transaction and a transactions module monitors and displays information associated with the transaction.

The system provides a real estate transaction management platform (or general project management platform, with a color-coded graphical interface with task prioritization and a sequential end-to-end workflow diagram. The application program also provides an integrated real estate buyer & seller client journey graphical dashboard with lead follow-up and tracking and notification system to aid in making the real estate transaction process for efficient for buyers and sellers.

The system may utilize artificial intelligence (AI) and machine learning (ML) to autonomously or at least semi-autonomously execute various tasks performed using the system. This provides an efficient means of automating tasks performed by the system to ensure accuracy and improve efficiency.

The system may be utilized for various projects and processes to provide a project management tool. Embodiments described herein utilize the example of a real estate transaction. However, one skilled in the arts will readily understand that the embodiments may be applied to be utilized for various types of project management. Real estate processes and transactions may include any process and transactions associated with a real estate purchase, sale, transfer, etc. including title transfers and transactions, escrow transactions, mortgage transactions and transfers, etc.

In one aspect, a communications module is configured to transmit one or more lead follow-ups, a plurality of lead tracking information, a plurality of notifications, and a plurality of task information.

In one aspect, the communication module is in operable communication with the tasks module and the transactions module to enable the automated transmission of the communications to the one or more clients.

In one aspect, the user interface module provides a dynamic display of the one or more tasks.

In one aspect, the tasks module is configured to prioritize the one or more tasks and display the prioritized on or more tasks in a client funnel interface.

In one aspect, the client funnel interface displays one or more transactions between at least one buyer and at least one seller.

In one aspect, the tasks module is in operable communication with a tasks process interface to illustrate one or more visual representations of the one or more tasks, and wherein the one or more tasks are each associated with at least one transaction.

In one aspect, the tasks process interface is color-coded to indicate a project status.

In one aspect, the tasks process interface is color-coded to indicate the priority associated with the project.

In one aspect, the transactions module is in operable communication with the tasks module to associate the transaction with one or more tasks.

In one aspect, the tasks module parses tasks to correspond to a priority level and a frequency at which each of the one or more tasks is to be performed.

In one aspect, the system includes an integrated file management system which aggregates files, documents, and information associated with each task, such that information is automatically organized. This may be accomplished through the use of the AI engine and/or machine learning engines.

In one aspect, the system provides a knowledge base of all executed contract files storage and sharing. This allows the system to aggregate and organize executed contract files.

In one aspect, the system allows for the customization and sharing of transactions, task statuses, associated files, and the like between all parties associated with the transaction. The system provides dedicated client and partner interfaces such that information contained within the client and partner interfaces is customized and tailored to the specific user-type.

In one aspect, a prospects module provides lead generation functionalities. The prospects module may be configured to be associated with a link, QR code, etc. which is associated with a lead. This allows the lead to be tracked using the prospects module and information associated with the lead to be organized within the system.

In one aspect, the system provides an end-to-end view of transactions performed using the system. Tasks are color-coded and provided in a prioritized listing which provides an efficient means of viewing the status and progress of each task associated with a transaction.

In one aspect, the communication module provides customizable and sharable email and transaction templates. The templates may be distributed by team leaders, brokerages, franchises, associations, MLS's, coaches, etc.

In one aspect, the system provide collaborative and internal communication capabilities between team members and external parties, such as clients and partners.

In one aspect, the system provides the ability to set targets (i.e., goals, milestones, etc.) for a period of time (e.g., a year, month, etc.). This allows the system to monitor the targets and their progress automatically.

### BRIEF DESCRIPTION OF THE DRA WINGS

A more complete understanding of the embodiments, and the attendant advantages and features thereof, will be more readily understood by references to the following detailed description when considered in conjunction with the accompanying drawings wherein:

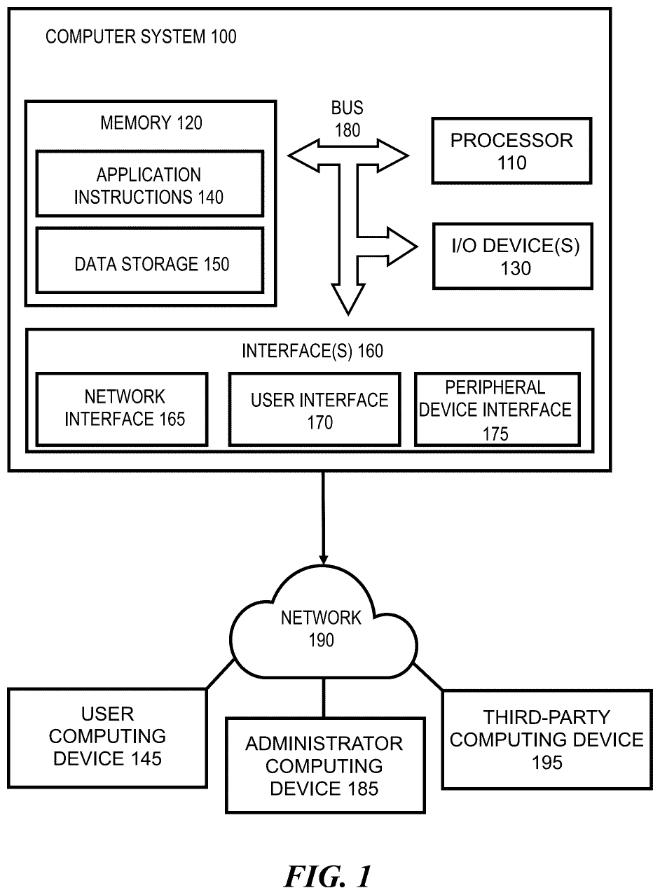

FIG. 1 illustrates a system architecture diagram, according to some embodiments;

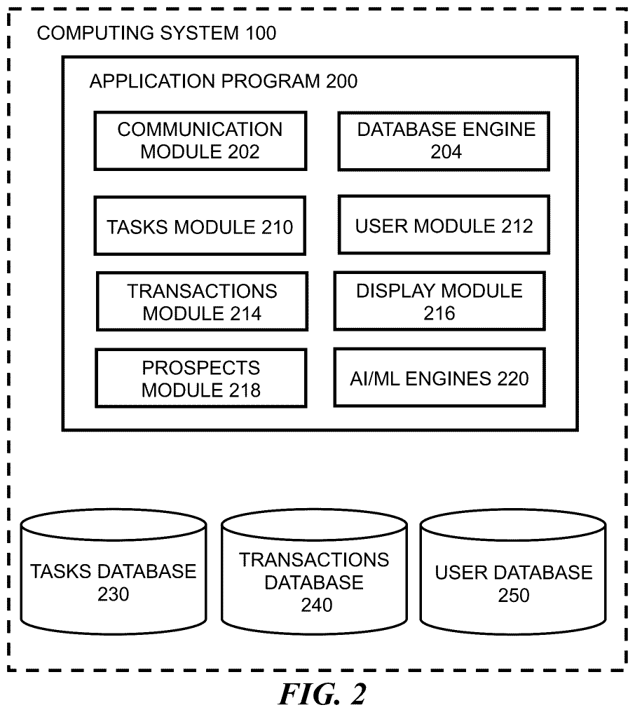

FIG. 2 illustrates an application program and modules in communication with the computing system, according to some embodiments;

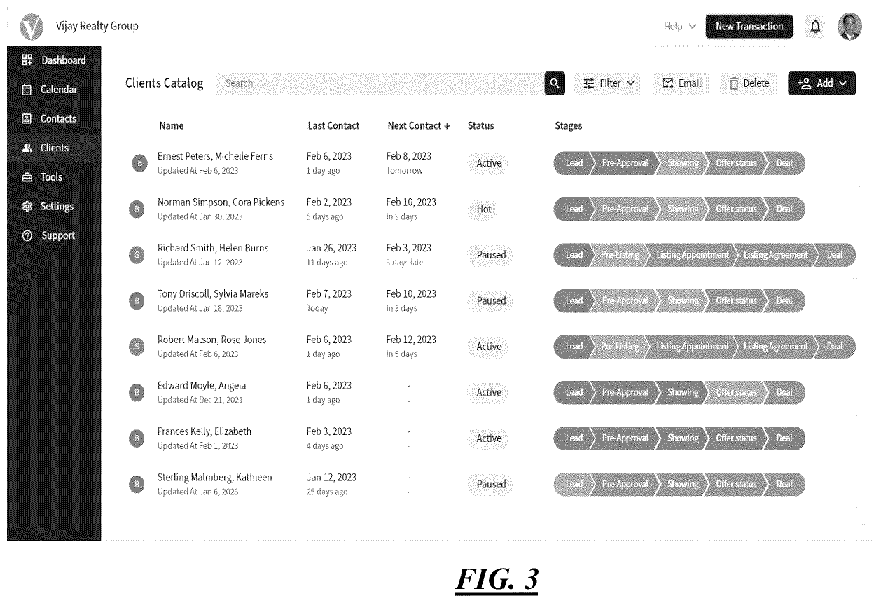

FIG. 3 illustrates a screenshot of the client catalog interface, according to some embodiments;

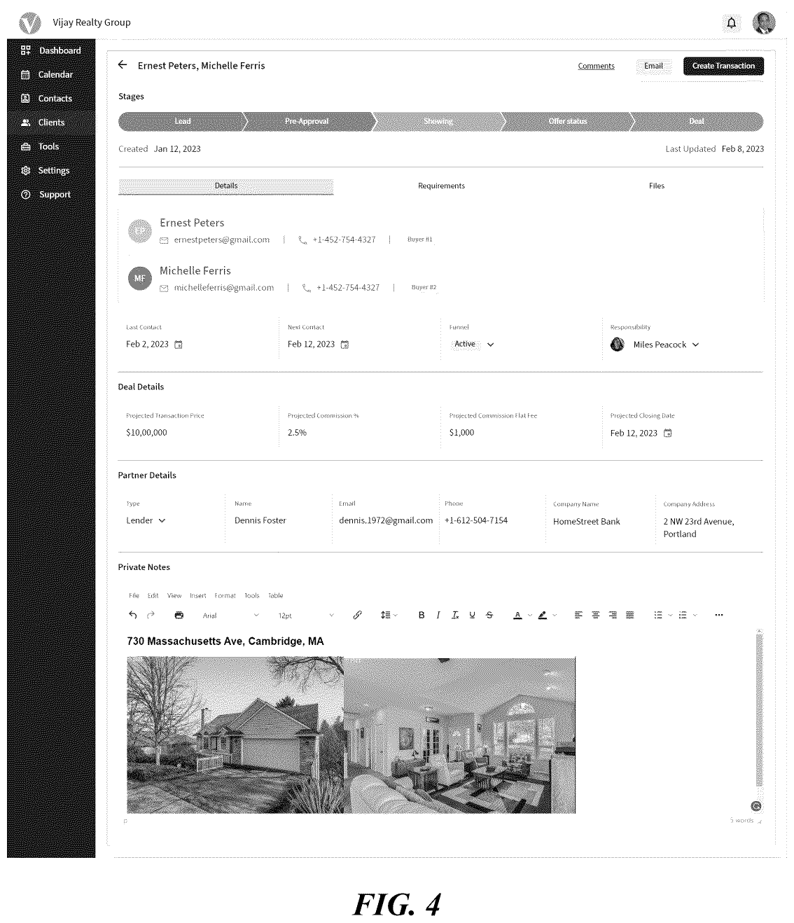

FIG. 4 illustrates a screenshot of the client information interface, according to some embodiments;

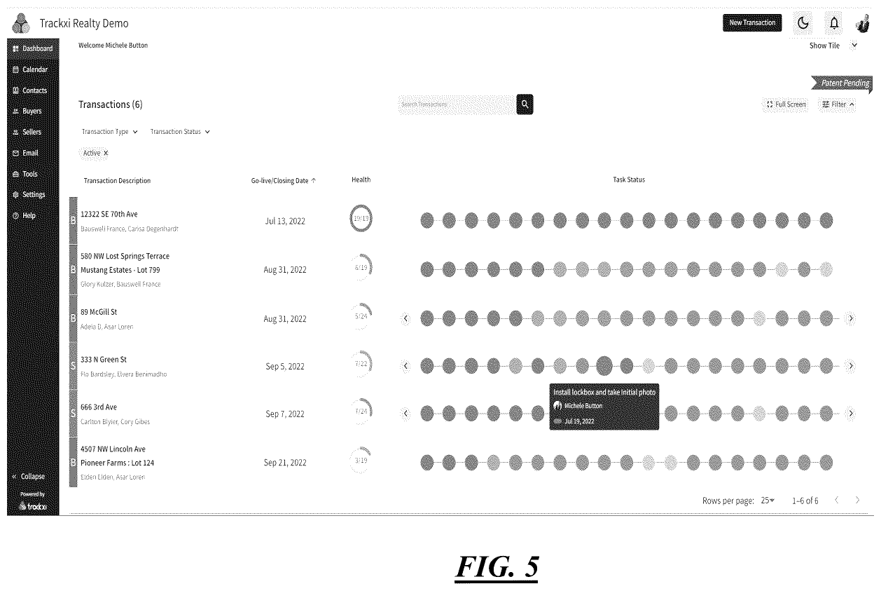

FIG. 5 illustrates a screenshot of the transactions interface, according to some embodiments;

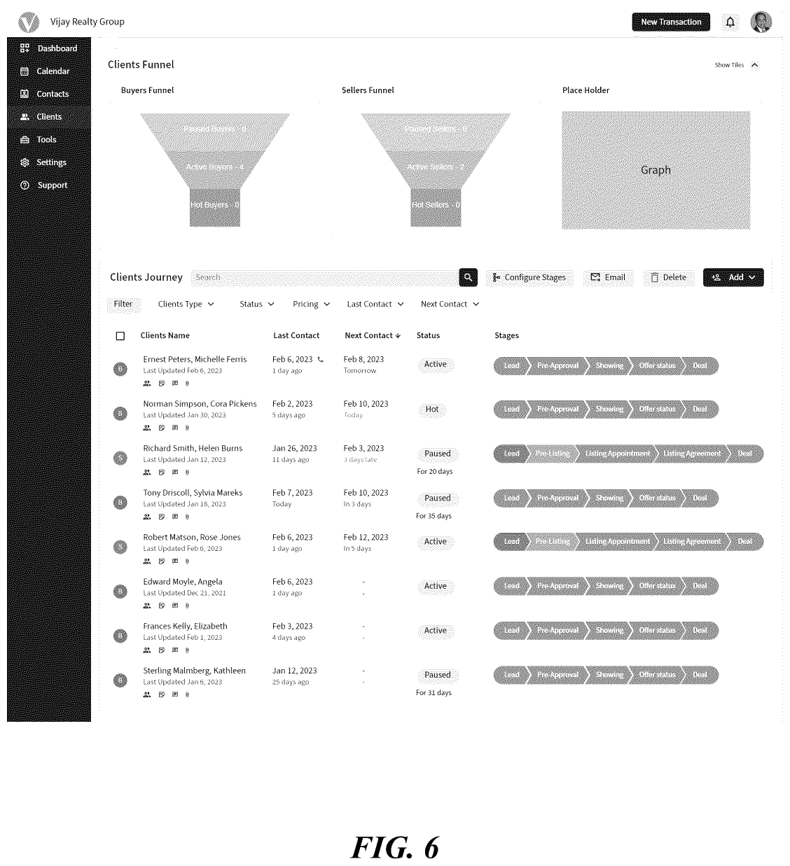

FIG. 6 illustrates a screenshot of the client funnel interface, according to some embodiments;

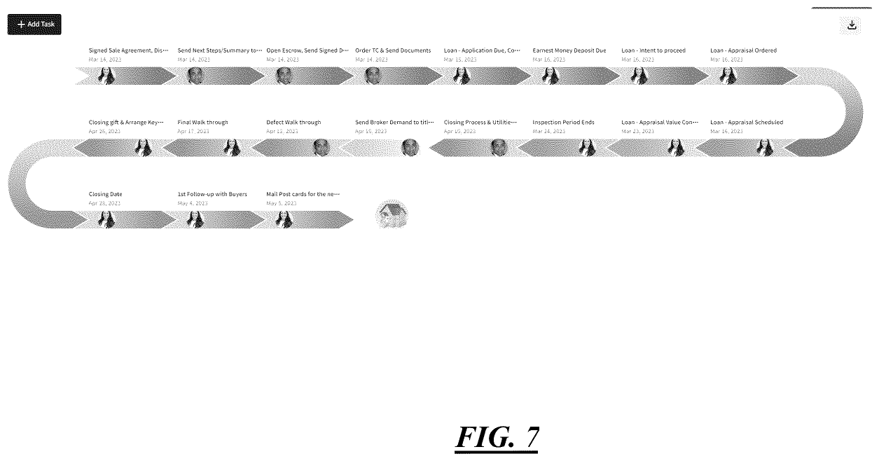

FIG. 7 illustrates a screenshot of the task process interface, according to some embodiments;

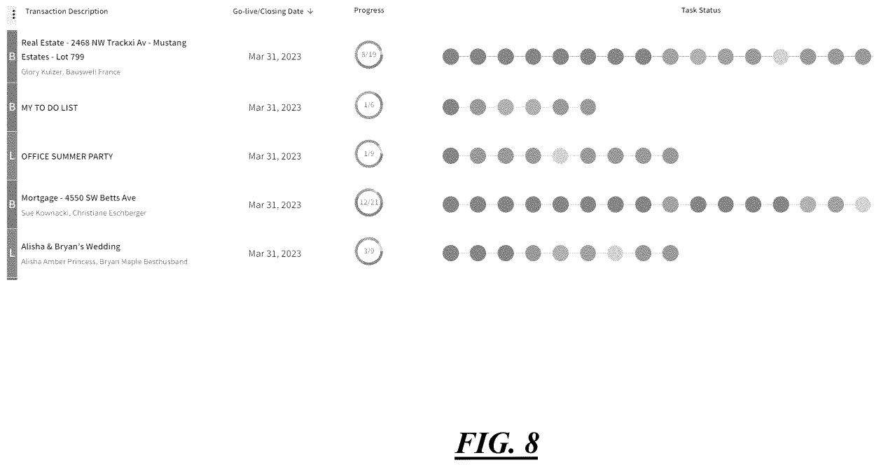

FIG. 8 illustrates a screenshot of the transaction process interface, according to some embodiments; and

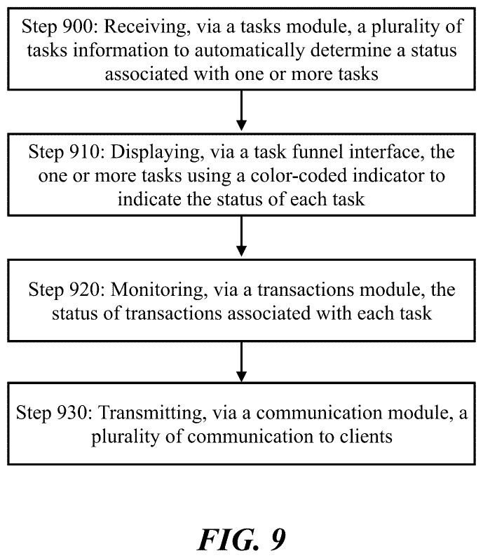

FIG. 9 illustrates a flowchart of a method for monitoring tasks associated with a real estate, mortgage, or other transaction.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relates to a real estate transaction management platform which provides a high level overview of all real estate transactions in a single location. The application program provides a prioritized and color-coded list of key tasks that needs to be performed on a daily basis. Further, the system provides graphical steps from start to completion of the transactions as well as an integrated real estate buyer & seller client journey graphical dashboard with a lead follow-up and tracking and notification system. Prioritized tasks may also be determined and displayed to clients (buyers & sellers) and partners (lenders, title companies, legal advisors, co-op brokers and other parties of the transaction).

The system may be utilized for various projects and processes to provide a project management tool. Embodiments described herein utilize the example of a real estate transaction. However, one skilled in the arts will readily understand that the embodiments may be applied to be utilized for various types of project management.

The system may be capable of providing a comprehensive management and tracking platform. Real estate processes and transactions monitored and tracked by the system may include any process and transactions associated with a real estate purchase, sale, transfer, etc. including title transfers and transactions, escrow transactions, mortgage transactions and transfers, etc.

In some embodiments, the system described herein may be used for client tracking throughout the business development and project execution processes.

In some embodiments, the system allows for the ability to seamlessly share a transaction with various other parties (e.g., a buyer, a buyer agent, a seller, a seller agent, a lender, a title company, and other parties associated with any form of project and transaction management). Users may select one or more tasks to be shared with one or more parties to automate communication between parties throughout the process.

The task list provides a very high-level overview to the agents at any time making it easy for them to complete prioritized tasks, so they will never miss an important task or a deadline. Easy to filter based on user requirements to service their clients. Notifications may be automated, including those for tasks due, birthdays, closing anniversary and others so these tasks can be performed consistently. Transactions can also be shared with clients and partners.

The application program provides a single dashboard for all transactions, color-coded automatic graphical prioritization, automated early warning system, end to end view of the overall transaction workflow sharable with clients and partners, integrated client journey with follow up and all the above features. The application program provides visual indications which pinpoint the tasks that must be completed on the due date, comprehensive view of the entire business, reduces the anxiety and enhances client satisfaction.

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, Kotlin, Java, ReactJS or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized a user (e.g., a healthcare provider) to interact with the various functionalities of the system including to perform patient rounds, handoff patient rounding responsibility, perform biometric verification tasks, and other associated tasks and functionalities of the system. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

FIG. 2 illustrates an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a tasks module 210, a user module 212, a transactions module 214, a display module 216, a prospects module 218, and AI/ML engines 220.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195.

The communication module 202 may be operable in communicating various information to clients including lead follow-ups, lead tracking, notifications, task information, and the like. Notifications and other communications may be automated, including those for tasks due, birthdays, closing anniversary, etc.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

In some embodiments, the database engine 214 is in operable communication with a tasks database 230, a transactions database 240, and a user database 250. The tasks database 230 is operable to store task information including lead follow-ups, lead tracking information, task statuses, priorities, and the like. The transactions database 240 is operable to store a plurality of transaction information including a transaction status, transaction priority, and the like. The user database 250 is operable to store a plurality of user information which may include buyer information, seller information, client information, and third-party user information. Information stored in the tasks database 230, a transactions database 240, and a user database 250 may be utilized to automatically and autonomously update the user interfaces illustrated in FIGS. 3-8.

In some embodiments, the tasks module 210 is configured to prioritize tasks which may also be inferred from information stored in the database. The tasks module 210 may provide a prioritized and color-coded list of key tasks that needs to be performed on a daily basis. Further, the system provides graphical steps from start to completion of the transactions as well as an integrated real estate buyer & seller client journey graphical dashboard with a lead follow-up and tracking and notification system.

In some embodiments, the user module 212 facilitates the creation of a user account for the application system. The user module 212 may allow the user to create a user profile which includes user information, user preferences, and user-associated information. The user module 212 may also allow for administrators to match users via information included in their user profile.

In some embodiments, the transactions module 214 is in operable communication with the computing device to display various information related to real-estate transactions. The transactions module 214 may be in communication with the tasks module 210 to determine if tasks related to a transaction have been completed, are in-progress, or need to be completed.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 provides alerts to the user device which can be viewed and acknowledged by the user.

In some embodiments, the prospects module 218 provides lead generation functionalities. The prospects module 218 may be configured to be associated with a link, QR code, etc. which is associated with a lead. This allows the lead to be tracked using the prospects module 218 and information associated with the lead to be organized within the system. In such, the prospects module 218 provides a means for monitoring prospective leads which have not yet proceeded towards the transaction process.

In some embodiments, the AI/ML engines 220 provide AI and machine learning engine integrations with the system to provide automated capabilities for various aspects and functionalities. For example, the AI/ML engines 220 may automate communications transmitted between users of the system. In another example, the AI/ML engines 220 provide a means of automatically updating and monitoring task statuses.

In some embodiments, the system provides an end-to-end view of transactions performed using the system. Tasks are color-coded and provided in a prioritized listing which provides an efficient means of viewing the status and progress of each task associated with a transaction.

In some embodiments, the communication module provides customizable and sharable email and transaction templates. The templates may be distributed by team leaders, brokerages, franchises, associations, MLS's, coaches, etc.

In some embodiments, the system provide collaborative and internal communication capabilities between team members and external parties, such as clients and partners.

In some embodiments, the system provides the ability to set targets (i.e., goals, milestones, etc.) for a period of time (e.g., a year, month, etc.). This allows the system to monitor the targets and their progress automatically.

FIGS. 3-8 illustrates various user interfaces of the application program. FIG. 3 illustrates a client catalog interface which allows the user to view client information, contact history, status of the client (e.g., active, paused), and stage of the transaction the client is in. FIG. 4 illustrates a screenshot of the client information interface wherein specific details regarding a client are displayed including notes, status, stage of the transaction process, and contact information. FIG. 5 illustrates a screenshot of the transactions interface wherein transaction details and status are displayed. FIG. 6 illustrates a screenshot of the client funnel interface wherein a buyers and sellers funnel is provided including transactions between with the buyers and sellers. FIG. 7 illustrates a screenshot of the tasks process interface which shows a visual representations of tasks associated with a transaction. FIG. 8 illustrates a screenshot of the color-coded transaction process interface.

In some embodiments, the color coded dashboard illustrated in FIGS. 3-8 illustrate color-coded interfaces which provide an efficient high-level overview of the project status at each task stage. FIG. 7 illustrates a color-coded end-to-end view of a transaction with prioritization of clients based on project stage and tasks completed.

FIG. 9 illustrates a method for providing a project management platform to monitor real estate, mortgage or other associated transactions. In step 900, the tasks module receives a plurality of task information to automatically determine a status associated with one or more tasks. In step 910, a task funnel interface displays the one or more tasks using a color-coded indicator, the color-coded indicator to indicate the status of each of the one or more tasks. In step 920, the transactions module monitors the status associated with a transaction, wherein the transaction is associated with each of the one or more tasks. In step 930, the communication module transmits a plurality of communication to the one or more clients.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for providing a project management platform, the system comprising:
at least one user computing device in operable connection with a user network;
an application server in operable communication with the user network, the application server configured to host an application system for providing a real estate management platform, the application system having a user interface module for providing access to the application program through the user computing device;
a tasks module in communication with the application program, the tasks module to monitor and display information related to one or more tasks associated with a transaction; and
a transactions module to monitor and display information associated with the transaction.

2. The system of claim 1, wherein the user interface module provides a dynamic display of the one or more tasks.

3. The system of claim 2, wherein the tasks module is configured to prioritize the one or more tasks and display the prioritized on or more tasks in a client funnel interface.

4. The system of claim 3, wherein the client funnel interface displays one or more transactions between at least one buyer and at least one seller.

5. The system of claim 3, wherein the tasks module is in operable communication with a tasks process interface to illustrate one or more visual representations of the one or more tasks, and wherein the one or more tasks are each associated with at least one transaction.

6. The system of claim 5, wherein the tasks process interface is color-coded to indicate a project status.

7. The system of claim 6, wherein the tasks process interface is color-coded to indicate the priority associated with the project.

8. The system of claim 1, wherein the transactions module is in operable communication with the tasks module to associate the transaction with one or more tasks.

9. The system of claim 1, wherein the tasks module parses tasks to correspond to a priority level and a frequency at which each of the one or more tasks is to be performed.

10. A system for providing an end-to-end project management platform, the system comprising:
at least one user computing device in operable connection with a user network;
an application server in operable communication with the user network, the application server configured to host an application system for providing a real estate management platform, the application system having a user interface module for providing access to the application program through the user computing device;
a tasks module in communication with the application program, the tasks module to monitor and display information related to one or more tasks associated with a transaction;
a transactions module to monitor and display information associated with the transaction to provide end-to-end management of the transaction;
a communication module to enable the transmission of communications to one or more clients; and
an AI/ML engine to provide automated communications and automated tasks status updates.

11. The system of claim 10, wherein the communications module is configured to transmit one or more lead follow-ups, a plurality of lead tracking information, a plurality of notifications, and a plurality of task information.

12. The system of claim 11, wherein the communication module is in operable communication with the tasks module and the transactions module to enable the automated transmission of the communications to the one or more clients.

13. The system of claim 12, wherein the user interface module provides a dynamic display of the one or more tasks.

14. The system of claim 13, wherein the tasks module is configured to prioritize the one or more tasks and display the prioritized on or more tasks in a client funnel interface.

15. The system of claim 14, wherein the client funnel interface displays one or more transactions between at least one buyer and at least one seller.

16. The system of claim 15, wherein the tasks module is in operable communication with a tasks process interface to illustrate one or more visual representations of the one or more tasks, wherein the one or more tasks are each associated with at least one transaction, and wherein the tasks module parses tasks to correspond to a priority level and a frequency at which each of the one or more tasks is to be performed.

17. The system of claim 16, wherein the tasks process interface is color-coded to indicate a project status.

18. The system of claim 17, wherein the tasks process interface is color-coded to indicate the priority associated with the project.

19. The system of claim 18, wherein the transactions module is in operable communication with the tasks module to associate the transaction with one or more tasks.

20. A method for providing a project management platform, the method comprising the steps of:
receiving, via a tasks module in communication with an application program, a plurality of task information to automatically determine a status associated with one or more tasks;
displaying, via a task funnel interface, the one or more tasks using a color-coded indicator, the color-coded indicator to indicate the status of each of the one or more tasks;
monitoring, via a transactions module, the status associated with a transaction, wherein the transaction is associated with each of the one or more tasks; and
transmitting, via a communication module, a plurality of communication to the one or more clients,
wherein an AI/ML engine automates the displaying, monitoring, and transmitting of information.
